(19) United States
(12) Patent Application Publication
(10) Pub. No.: US 2005/0145670 A1
(43) Pub. Date: Jul. 7, 2005

(54) Adjustment device of floor nail driver

(76) Inventor: Wen-Sheng Huang, Taichung Hsien (TW)

Correspondence Address: CHANG YING CHEN, 235 CHUNG-HO BOX 8-24, TAIPEI HSIEN, TW

(21) Appl. No.: 10/746,684

(22) Filed: Dec. 29, 2003

(51) Int. Cl. B25C 7/00

(52) U.S. Cl. 227/148; 227/151

(57) ABSTRACT

An adjustment device of a floor nail driver includes an adjusting body; a base; one end of a base having a clamping portion; an adjusting body being installed in the base for adjusting the elevation of the base. One end of the adjusting body is installed with a clamping sheet and a retaining bar and an adjusting button is installed in the retaining bar. The clamping portion is formed with a plurality of grooves. The clamping sheet is installed to the clamping portion and the retaining bar is buckled to one groove; and then the adjusting button is tightened so as to fix the adjusting body to the base. An upper side of the adjusting body is hollowed. A flat surface is formed between each two grooves. A structure for adjusting the elevation is added so that the problem that the wood floor is too thin or too thick can be resolved.

### FIELD OF THE INVENTION

The present invention relates to nail drivers, and particular to an adjustment device of a floor nail driver, wherein a structure for adjusting the elevation is added so that the problem induced from the wood floor being too thin or too thick can be resolved. The connection of the wood floor and the floor nail is firmly.

### BACKGROUND OF THE INVENTION

In general, floor nails are used to fix wood floors with corners strips so as to fix lifted wood floors. With reference to FIGS. 7, 8 and 9, in the prior art, the floor nails us beaten into the wood floors with a predetermined height, as shown in FIG. 7. The height in shooting the nail cannot be adjusted real time. If the wood floor is too thin or too thick (referring to FIGS. 8 and 9), it is possible that the floor nail is not beaten into the wood floor or only into the wood floor but not beaten into the strip. Thereby, the object of combining the wood floor and the strip tightly cannot be achieved. Thereby, it is necessary to be improved.

### SUMMARY OF THE INVENTION

Accordingly, the primary object of the present invention is to provide an adjustment device of a floor nail driver, wherein a structure for adjusting the elevation is added so that the problem that the wood floor is to thin or too thick can be resolved. The connection of the wood floor and the floor nail is firmly.

To achieve above objects, the present invention provides an adjustment device of a floor nail driver includes an adjusting body; a base; one end of a base having a clamping portion; an adjusting body being installed in the base for adjusting the elevation of the base. One end of the adjusting body is installed with a clamping sheet and a retaining bar and an adjusting button is installed in the retaining bar. The clamping portion is formed with a plurality of grooves. The clamping sheet is installed to the clamping portion and the retaining bar is buckled to one groove; and then the adjusting button is tightened so as to fix the adjusting body to the base. An upper side of the adjusting body is hollowed. A flat surface is formed between each two grooves. A structure for adjusting the elevation is added so that the problem that the wood floor is too thin or too thick can be resolved.

The various objects and advantages of the present invention will be more readily understood from the following detailed description when read in conjunction with the appended drawing.

### BRIEF DESCRIPTION OF THE DRAWINGS

FIG. 1 is an exploded perspective view of the adjustment device of a floor nail driver of the present invention.

FIG. 2 is a perspective view showing the adjusting body of the adjustment device of a floor nail driver of the present invention.

FIG. 3 is an assembled view of the adjustment device of a floor nail driver of the present invention.

FIGS. 4 to 6 are lateral views showing the use of the adjustment device of a floor nail driver of the present invention.

FIGS. 7 to 9 are schematic view about the prior art floor nail.

### DETAILED DESCRIPTION OF THE INVENTION

In order that those skilled in the art can further understand the present invention, a description will be described in the following in details. However, these descriptions and the appended drawings are only used to cause those skilled in the art to understand the objects, features, and characteristics of the present invention, but not to be used to confine the scope and spirit of the present invention defined in the appended claims.

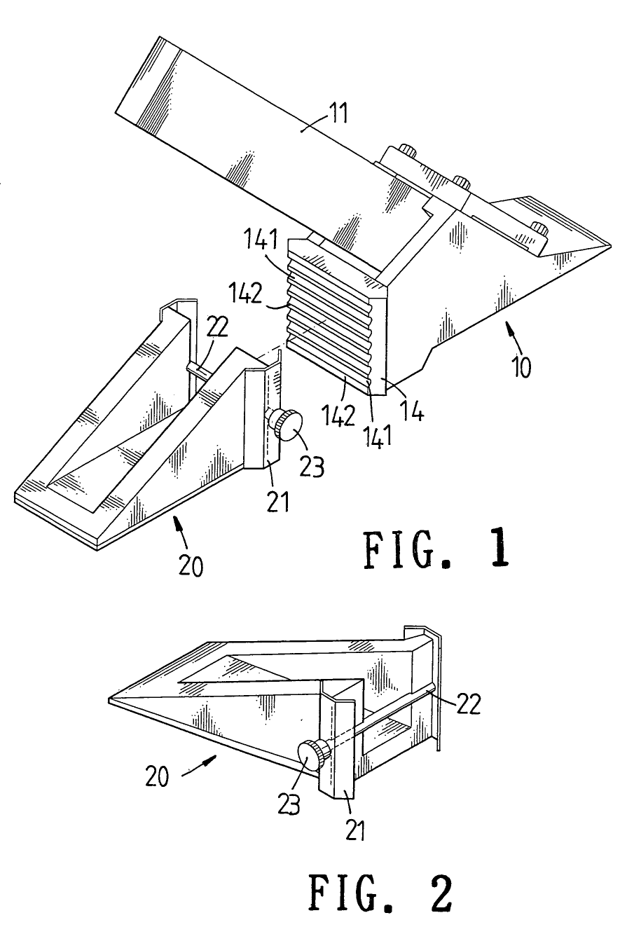

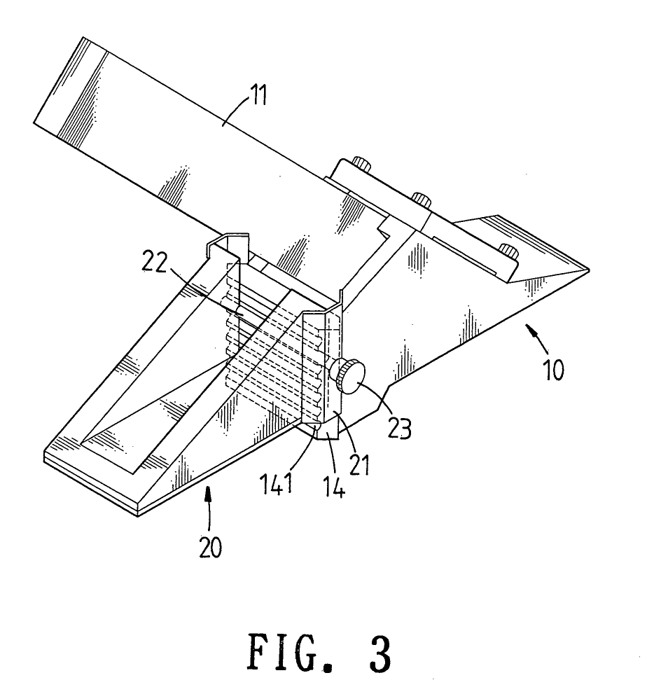

The adjustment device of a floor nail driver of the present invention is illustrated, as shown in FIG. 1. The adjustment device of a floor nail driver includes a base 10. A cartridge 11 receives in an upper space of the base 10. The cartridge 11 is installed so as to have an angle of 45 degrees with respect to a working surface. A nail outlet 12 is formed at a lower side of the base 10. The nail outlet 12 guides a nail out of the base 10 with an orientation vertical to the cartridge 11. A clamping portion 14 is formed at a front end of the base 10. A plurality of grooves 141 are formed in the clamping portion 14 for retaining. A flat surface is formed between each two grooves 141 for being adhered by other object.

An adjusting body 20 is a tapered body. An upper side of the adjusting body 20 is hollowed for interfering with the cartridge 11. A clamping sheet 21 and a retaining bar 22 are formed at one side of the adjusting body 20 facing the clamping portion 14 of the base 10. An adjusting button 23 is mounted to the retaining bar 22.

In assembly, it is only necessary to clamp the clamping portion 14 by the clamping sheet 21 and the retaining bar 22 is buckled to a selected groove 141. The adjusting button 23 serves to adjust the tightness of the clamping sheet 21 clamping the clamping portion 14. When it is desired to adjust the elevation of the adjusting body 20, the adjusting button 23 is released, the adjusting body 20 is moved to a desired elevation with respect to the base 10. Then the retaining bar 22 is buckled to a respective groove 141 and then the adjusting button 23 is tightened.

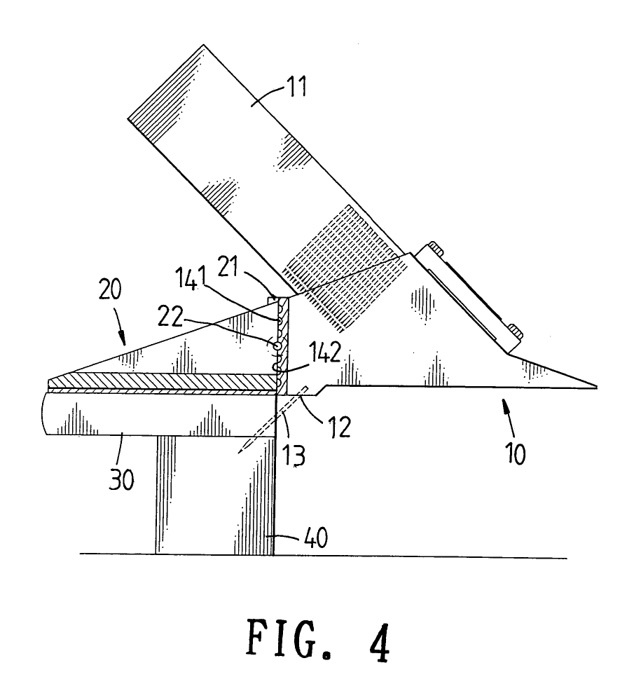

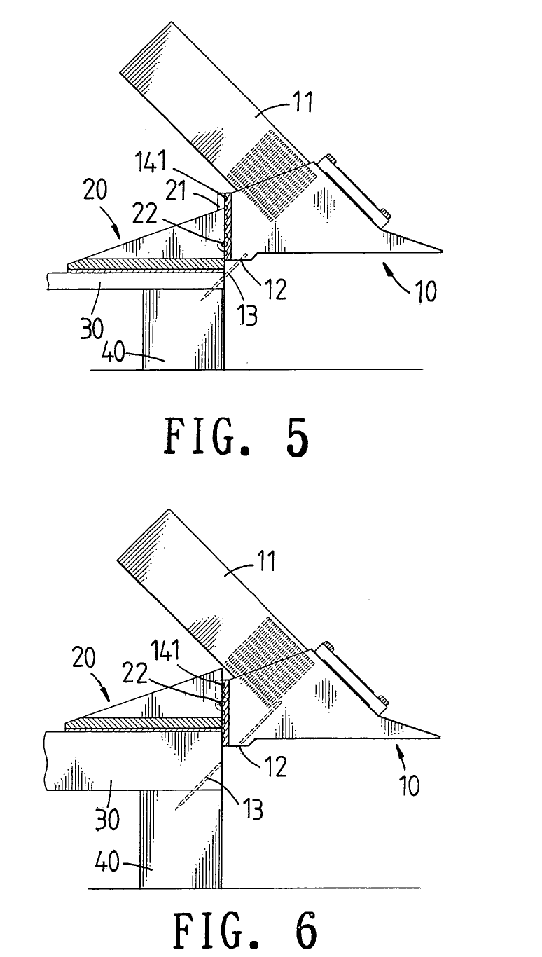

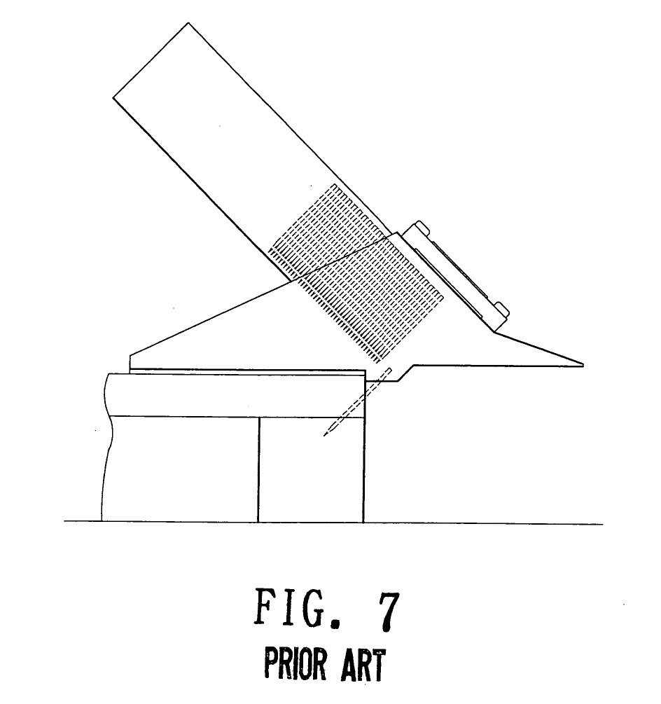

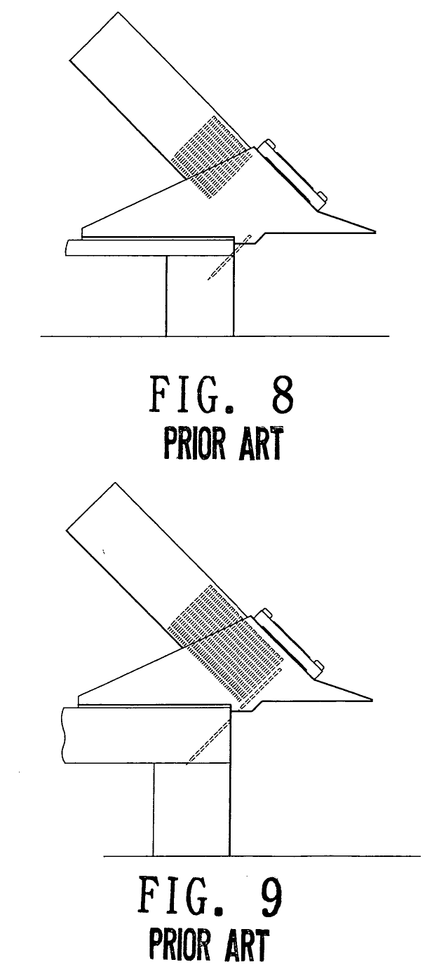

Referring to FIGS. 4 and 6, the use of the present invention is illustrated. In general use (referring to FIG. 4), after assembly, the elevation is unnecessary to be adjusted. The adjusting body 20 is flushed with a wood floor 30. The floor nail 13 is beaten into the wood floor 30 and a strip 40 with a correct angle so that the wood floor 30 is tightly adhered to the strip 40 by using the floor nail 13.

If the wood floor 30 is too thin (referring to FIG. 5), the floor nail driver is adjustable. As above said operation way, the base 10 is adjusted to a higher position with respect to the adjusting body 20. Then the floor nail 13 is beaten. If the wood floor 30 is too thick (referring to FIG. 6), it is only necessary to lower the base 10 with respect to the adjusting body 20 so that the bottom surface of the adjusting body 20 flushes with the wood floor 30. Then the flat surfaces 142 flushes with the wood floor 30 and the strip 40. Then the floor nail 13 can be beaten thereinto so that the wood floor 30 is more tightly adhered to the strip 40.

As above said, in the preferred embodiment of the present invention, other than the adjusting body 20 is hollowed so as to avoid that the cartridge 11 is interfered with the adjusting body 20. A structure for adjusting the elevation is added in the present invention so that the problem that the wood floor 30 is too thin or too thick can be resolved. Thereby, the floor nail 13 can be beaten into the wood floor 30 and the strip 40. The floor nails 13 are obliquely beaten into wood floor 30 and the strip 40 in the wide area so that the floor nails 13 can suffer from the stress force and normal force. Thus the connection of the wood floor 30 and the floor nail 13 is firmly.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

1-6. (canceled)

7. An adjustment device of a floor nail driver comprising:
an adjusting body being a tapered body having a flat bottom so as to be flatly adhere to a floor to be nailed by a nail outputted from the floor nail driver; an upper side of the adjusting body being hollowed
a base; one end of a base having a clamping portion; the adjusting body being installed in the base for adjusting the elevation of the base;
a cartridge received in an upper space of the base; a nail outlet being formed at a lower side of the base; the nail outlet guiding a nail out of the base with an orientation vertical to the cartridge;
wherein one end of the adjusting body is installed with a clamping sheet and a retaining bar; and an adjusting button is installed in the retaining bar for adjusting the retaining bar so that the clamping sheet is able to clamp the adjusting body to tightly adhere to the base; and
the clamping portion is formed with a plurality of grooves; the clamping sheet is installed to the clamping portion and the retaining bar is buckled to one of the plurality of grooves; and then the adjusting button is tightened so as to fix the adjusting body to the base.

8. The adjustment device of a floor nail driver as claimed in claim 1, wherein a flat surface is formed between each two grooves.

9. The adjustment device of a floor nail driver as claimed in claim 2, wherein a flat surface is formed between each two grooves.

10. The adjustment device of a floor nail driver as claimed in claim 1, wherein the cartridge is installed so as to have an angle of 45 degrees with respect to a working surface.
